(19) United States
(12) Patent Application Publication
(10) Pub. No.: US 2005/0244029 A1
(43) Pub. Date: Nov. 3, 2005

(54) Speaker apparatus and speaker diaphragm

(75) Inventors: Koji Takayama, Tendo-shi (JP); Takahisa Haba, Tendo-shi (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/117,530

(22) Filed: Apr. 29, 2005

(30) Foreign Application Priority Data
Apr. 30, 2004 (JP) P2004-135001

(51) Int. Cl. H04R 25/00

(52) U.S. Cl. 381/398; 381/404

(57) ABSTRACT

A speaker apparatus including a diaphragm for emitting sound; and a frame for holding the diaphragm, wherein the diaphragm has a bent portion along inner periphery of the frame.

### BACKGROUND OF THE INVENTION

1. Field of the Invention

The present invention relates to a technical field of a speaker apparatus and a speaker diaphragm used in various audio equipments.

2. Related Art

In a conventional technique of Japanese Unexamined Patent Publication JP-A-2002-247686, it is disclosed that a composite diaphragm is obtained by laminating resin films which are front and back skin substrates on an intermediate layer which is made of a reconstituted mica sheet, an aluminum alloy sheet, or a titanium alloy sheet and by heating and pressing thus laminated films and layers.

Further, as another diaphragm for a speaker, Japanese Unexamined Patent Publication JP-A-2000-152376 discloses a composite diaphragm obtained by laminating a composite sheet on a molded product obtained by heating and pressing a paper, which is obtained by mixing a water resistant synthetic fiber and a natural pulp fiber and squeezing the mixture to dehydrate, to be in a shape of diaphragm. The composite sheet has a film structure demonstrating an excellent junction property that takes place on the highly water-resistant film.

In the conventional diaphragms, there may occur a deformation in the main body of the diaphragm, because the diaphragms are the composite diaphragm formed by laminating the resin film on the paper mold, the cloth mold or the alloy sheet, and therefore materials configuring the composite diaphragm respectively have different contraction percentages to thereby frequently cause deformation of the main body in accordance with circumstance change.

In the above conventional techniques, the outer peripheral shape of the main body of the diaphragm of the speaker apparatus is shaped like a single circular arc or a straight line. No direct countermeasure to the deformation in the main body of the diaphragm is considered.

The present invention is provided to solve the above problems and to provide a diaphragm for speaker and a speaker apparatus which are free of deformation.

According to a first aspect of the present invention, there is provided a speaker apparatus comprising:
a diaphragm for emitting sound; and
a frame for holding the diaphragm, wherein
the diaphragm has a bent portion along inner periphery of the frame.

According to a second aspect of the present invention, there is provided a speaker apparatus according to the first aspect, wherein the bent portion of the diaphragm is formed in the vicinity of an edge portion of the diaphragm.

According to a third aspect of the present invention, there is provided a speaker apparatus according to the first aspect, wherein the bent portion is formed by bending an outer peripheral portion toward a front surface side or a back surface side with respect to the diaphragm.

According to a fourth aspect of the present invention, there is provided a speaker apparatus according to the first aspect, wherein the angle of the bent portion is within 90 degrees.

According to a fifth aspect of the present invention, there is provided a speaker apparatus according to the first aspect, wherein the diaphragm is formed by laminating a paper mold or a cloth mold on a cloth mold through a film.

According to a sixth aspect of the present invention, there is provided a speaker apparatus according to the first aspect further comprising an edge portion which is integrally formed with the diaphragm.

According to a seventh aspect of the present invention, there is provided speaker apparatus according to the first aspect, further comprising an edge portion which is attached to the diaphragm.

### BRIEF DESCRIPTION OF THE DRAWINGS

In the accompanying drawings:

FIG. 1 is a schematic cross-sectional view of a speaker apparatus according to an embodiment of the present invention;

FIG. 2 is a cross-sectional view of the diaphragm shown in FIG. 1;

FIG. 3 is a cross-sectional view of the diaphragm and an edge portion shown in FIG. 1; and

FIG. 4 is a cross-sectional view of the diaphragm of the speaker apparatus according to another embodiment.

### DESCRIPTION OF THE PREFERRED EMBODIMENTS

Preferred embodiments of the present invention will be described in conjunction with the figures. Hereinafter, each meaning of the reference numbers in the drawings is as follows:
1: speaker apparatus, 8: diaphragm (tympanum), 9: edge portion, 10: frame, and 12: bent portion.

### Embodiment 1

An embodiment of the present invention will be described in reference of the figures.

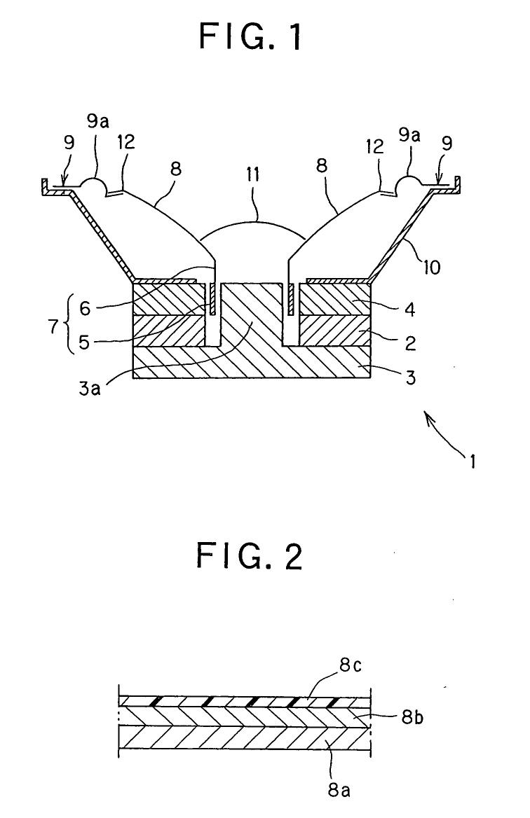

FIG. 1 is a schematic cross-sectional view of a speaker apparatus according to an embodiment of the present invention.

As shown in FIG. 1, the speaker apparatus 1 is made up of a magnet 2, a center piece 3 attached to a lower surface of the magnet 2, a yoke 4 attached to an upper surface of the magnet 2, a voice coil 5 arranged in a magnetic gap which is formed between the center piece 3 and the yoke 4, a bobbin 6 for attaching the voice coil 5, a diaphragm 8 attached to the coil bobbin 7 which is formed by the voice coil 5 and the bobbin 6, an edge portion attached to an outer periphery of the diaphragm 8, a frame 10 for arranging the diaphragm 8 to a predetermined position through the edge portion 9, and a center cap 11 arranged in a center of the diaphragm The magnet 2 is for example made from a magnetic material having a high magnetic flux density such as a neodymium magnet, and shaped like a disk having a hole in a center thereof.

The center piece 3 is made from a magnetic material of for example iron or an alloy of iron and is attached to a lower surface of the magnet 2. The center piece 3 has a shape that a protrusion 3a is formed in a center thereof. The protrusion 3a is inserted into the hole formed in the center of the magnet 2.

The yoke 4 is made from a magnetic material of for example iron or an alloy of iron, formed in a disk shape having a hole in a center thereof, and attached to an upper surface of the magnet 2. A magnetic gap is formed between an inner peripheral surface of the yoke 4 and an outer peripheral surface of the center piece 3 at a position opposite to the inner peripheral surface.

The voice coil 5 is for example made from a copper wire and wound around the bobbin 6.

The bobbin 6 is made from for example a craft paper or a heat resistance plastic, wherein one end thereof is fixed to the diaphragm 8 and the voice coil 5 is wound around the other end thereof. The coil bobbin 7 is made up of the voice coil 5 and the bobbin 6.

The diaphragm 8 is formed by laminating a hot-chamber molded synthetic fiber or a chemical fiber 8c on a paper diaphragm 8a through a film 8b as shown in FIG. 2.

The edge portion 9 is made from for example by a cloth, an urethane, or a rubber to restore a predetermined position when the diaphragm 8 vibrates. One end of the edge portion 9 has a portion bonded to the outer periphery of the diaphragm 8 through a semicircular portion 9a and the other end has a portion attached to the frame 10.

The center cap 22 is formed by press-molding a thin alloy plate of for example aluminum and prevents dust from intruding into the speaker apparatus 1.

The speaker apparatus 1 according to the present invention corresponds to a speaker apparatus according to the present invention. The diaphragm 8 corresponds to a vibration unit according to the present invention. The edge portion 9 corresponds to an edge portion according to the present invention. The frame 10 corresponds to a frame according to the present invention.

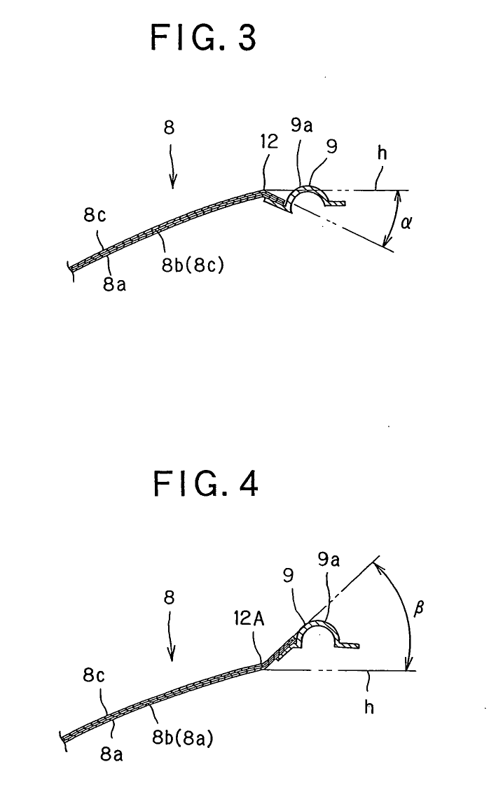

Incidentally, the cross sectional view of the diaphragm 8 according to this embodiment is shaped like a single smooth circular arc on its outer peripheral portion and also has the bent portion 12 on its outer peripheral portion other than the edge portion 9. In other words, the bent portion 12 is formed by bending the outer peripheral portion of the diaphragm in the vicinity of the edge portion 9 toward a back surface side with respect to a line h which is perpendicular to a direction of emitting sound (a downward in FIG. 3).

Further, the bent portion 12 is bent at an angle α within 90 degrees toward the back surface side with respect to the line h which is perpendicular to the sound emitting direction of the diaphragm 8.

Next, an operation of the diaphragm 8 according to the present invention will be described.

Ordinarily, when a film 8c is laminated on a cloth mold 8a through a paper mold 8b or a cloth mold 8a, the diaphragm 8 may deform because the contraction percentage by heat and humidity is changed. However, according to this embodiment, since the bent portion 12 in the outer peripheral portion and in the vicinity of the edge portion 9 makes the strength of the diaphragm 8 against deformation high, whereby an accommodation to circumstance such as heat and humidity can be improved.

When the bent portion 12 is formed on an inner peripheral side and in the peripheral direction of the diaphragm 8, not in the outer peripheral portion in the vicinity of the edge portion 9 of the diaphragm 8, an outer peripheral edge of the diaphragm 8 is extremely apart from the frame 10 to thereby obstruct the attachment of the diaphragm 8 to a predetermined position of the frame 10 through the edge portion 9. Accordingly, it is preferable to form the bent portion 12 in the outer peripheral portion of the diaphragm 8 in the vicinity of the edge portion of the diaphragm 8.

According to the diaphragm 8 of this embodiment, since the bent portion 12 is bent at the angle α within 90 degrees toward the back surface side with respect to the line which is perpendicular to the sound emitting direction of the diaphragm 8, the strength of the diaphragm 8 against deformation is increased, the accommodation to circumstance such as heat and humidity is improved, and it becomes possible to easily attach the diaphragm 8 to the predetermined position of the frame 10 through the edge portion 9.

When the angle α exceeds 90 degrees with respect to the line which is perpendicular to the sound emitting direction of the diaphragm 8 on the back surface side, the position of attaching the edge portion 9 to the frame 10 is apart. Then it becomes difficult to attach the diaphragm 8 to the predetermined position through the edge portion 9.

Further, in the speaker device according to this embodiment, the outer peripheral portion of the diaphragm 8 having the bent portion 12 is attached to the frame 10 through the edge portion 9 and the strength of the diaphragm 8 is enhanced by the bent portion 12. Therefore, the speaker apparatus 1 having improved accommodation to circumstance such as heat and humidity can be provided.

### Embodiment 2

FIG. 4 is a cross sectional view of the diaphragm in the speaker apparatus according to Embodiment 2 of the present invention. Because the structure of the diaphragm of the speaker apparatus according to the embodiment is basically similar to that of Embodiment 1, the same numerical references are used for the same or similar portions and description of the portions is omitted.

The bent portion 12A according to this embodiment is bent at an angle β within 90 degrees toward a front surface side (an upward direction in FIG. 4) with respect to a line h which is perpendicular to a direction of emitting sound from the diaphragm.

When the angle β exceeds 90 degrees toward the front surface side with respect to the line h which is perpendicular to the sound emitting direction of the diaphragm 8, since the position of attaching the edge portion 9 to the frame is separated from the frame 10 as in Embodiment 1, it becomes difficult to attach the diaphragm 8 in a predetermined position through the edge portion 9.

As such, in the diaphragm 8 according to this embodiment, since the bent portion is bent at the angle β within 90 degrees toward the front surface side with respect to the line h which is perpendicular to the sound emitting direction of the diaphragm 8, the strength of the diaphragm 8 against the deformation is enhanced in a similar manner to that in Embodiment 1. Therefore, the accommodation to circumstance such as heat and humidity can be improved, and the diaphragm 8 can be easily attached to the predetermined position through the edge portion 9.

The present invention is not limited to the above embodiments and various modifications are possible. For example, although the edge portion 9 and the diaphragm 8 may be separately formed and the edge portion 9 is attached to the diaphragm 8 in the above embodiments, an edge portion 9 may be integrally formed with a diaphragm 8. In this case, it is possible to reduce the number of parts, whereby a parts management cost and an industrial work cost can be decreased.

Further, although the example that the cross sectinal view of the diaphragm is formed to have a smooth shape is explained, the invention is not limited thereto and the effects similar to those of the embodiments are obtainable even though the cross sectional view of the diaphragm is shaped like a straight line.

The present invention is not confined to the configurations listed in the foregoing embodiments, but it is easily understood that the person skilled in the art can modify such configurations into various other modes, within the scope of the present invention described in the claims.

The entire disclosures of Japanese Patent Applications No. 2004-135001 filed on Apr. 30, 2004 including the specification, claims, drawings and summary are incorporated herein by reference in its entirety.

1. A speaker apparatus comprising:
a diaphragm for emitting sound; and
a frame for holding the diaphragm, wherein
the diaphragm has a bent portion along inner periphery of the frame.

2. A speaker apparatus according to claim 1, wherein
the bent portion of the diaphragm is formed in the vicinity of an edge portion of the diaphragm.

3. A speaker apparatus according to claim 1, wherein
the bent portion is formed by bending an outer peripheral portion toward a front surface side or a back surface side with respect to the diaphragm.

4. A speaker apparatus according to claim 1, wherein the angle of the bent portion is within 90 degrees.

5. A speaker apparatus according to claim 1, wherein the diaphragm is formed by laminating a paper mold or a cloth mold on a cloth mold through a film.

6. A speaker apparatus according to claim 1, further comprising an edge portion which is integrally formed with the diaphragm.

7. A speaker apparatus according to claim 1, further comprising an edge portion which is attached to the diaphragm.
